(19) United States
(12) Patent Application Publication
(10) Pub. No.: US 2016/0213047 A1
(43) Pub. Date: Jul. 28, 2016

(54) CARBONATE STIMULATION ENHANCER

(71) Applicant: T. HASEGAWA CO., LTD., Tokyo (JP)

(72) Inventors: Yuichiro OHMORI, Kanagawa (JP); Takahiro IWAMOTO, Kanagawa (JP); Satoshi FUJIWARA, Kanagawa (JP)

(73) Assignee: T. HASEGAWA CO., LTD., Tokyo (JP)

(21) Appl. No.: 14/916,212

(22) PCT Filed: Sep. 3, 2014
(86) PCT No.: PCT/JP2014/073203

§ 371 Date: Mar. 3, 2016

(30) Foreign Application Priority Data
Sep. 4, 2013 (JP) 2013-182883

(51) Int. Cl. A23L 2/40; A23L 2/54; A23L 2/52

(52) U.S. Cl. CPC A23L 2/40; A23L 2/52; A23L 2/54; A23V 2002/00

(57) ABSTRACT

[Problem] To provide a carbonate stimulation enhancer that allows maintenance of carbonate stimulation even for carbonated beverages that have reduced “carbonate stimulation sensation” because of decreased gas pressure during packing according to ingredients, decreased gas pressure due to gas permeability of containers or rapid degassing of gaseous carbonic acid after opening a container.

[Solution] Provided is a carbonate stimulation enhancer for enhancing and maintaining preferable carbonate stimulation of gaseous carbonic acid, which is obtained by the addition of an undecatriene and/or an undecatetraene as an active component to a carbonated beverage.

### TECHNICAL FIELD

The present invention relates to a carbonate stimulation enhancer and a method for enhancing carbonate stimulation by adding the enhancer to beverages. Specifically, the present invention relates to a carbonate stimulation enhancer containing an undecatriene or an undecatetraene as an active component.

### BACKGROUND ART

Carbonated beverages occupy a significant part in the beverage market along with tea beverages and coffee beverages and market share thereof is higher than those of beverages including fruit beverages, sports drinks and mineral water. Carbonated beverages have existed in the beverage market since a long time ago and been consumed for a long period of time, enriching people's everyday life all over the world. When water is lost in sweat on hot summer days or after exercises, the stimulus finish of carbonated beverages gives one a unique, pleasant cooling sensation on the throat and is highly favoured, along with the benefits of rehydration and sugar supplement.

Carbonated beverages are characterised by this unique “carbonation sensation” which other soft drinks do not possess. Carbonated beverages contain gaseous carbonic acid dissolved in water by pressurisation. It is believed that at normal pressure, the dissolved carbon dioxide effervesces in the water as bubbles of gaseous carbonic acid and the effervescence pressurises sensory cells or stimulates nociception of the tongue to generate a unique stimulus sensation.

It is also believed that carbonated beverages having stronger carbonate stimulation have more pleasant sensation and are highly favoured, and thus the need is high for beverages manufactured at increased pressure of gas.

However, in cases where gas pressure during packing of carbonated beverages containing fruit juice has to be reduced in accordance with heat sterilisation conditions, or where carbonated beverages “go flat” because of decreased gas pressure due to gas permeability of containers or rapid degassing of gaseous carbonic acid after opening a container, the pleasant and strong stimulus sensation of gaseous carbonic acid required for carbonated beverages is weakened, resulting in reduced “carbonate stimulation sensation”, and therefore sufficient palatability of carbonated beverages cannot be maintained.

For carbonated beverages, there has been proposed a method for producing a carbonated beverage having improved quality of taste including stimulation, creamy sensation and rich taste, the method comprising adding 0.5 to 5% by mass of a starch degradation product having DE 6 to 30 to the carbonated beverage (Patent Document 1); a carbonated beverage having rich taste of a plant component and pleasant stimulation due to gaseous carbonic acid produced by configuring the pressure of gaseous carbonic acid at a relatively high level and adding a certain amount of high-level sweetener to a formulation containing a high amount of plant component such as fruit juice (Patent Document 2); a method for enhancing or maintaining the carbonation sensation of a carbonated beverage comprising adding spilanthol or a plant extract or plant essential oil containing spilanthol to the carbonated beverage (Patent Document 3); a method for increasing fineness of effervescing sensation and palatability of a manufactured article comprising adding two or more components selected from Swertia japonica extract, ginger extract and rum ether to a carbonated beverage (Patent Document 4); a method for enhancing the carbonate stimulation of a carbonated beverage comprising adding a hydroxy acid ester (Patent Document 5); a method for increasing the creamy sensation of bubbles while drinking comprising adding δ-lactone (Patent Document 6) and the like.

However, methods including adding an acrid component alone to a carbonated beverage may confer an acrid taste while enhancing the carbonation sensation. In addition, other methods result in stronger improvement in the foaming sensation than enhancement of carbonate stimulation, resulting in enhancement of rich taste and creamy sensation without providing sufficient enhancement effect of pleasant carbonate stimulation.

### CITATION LIST

### Patent Literature

Patent Document 1: Japanese Patent Application Laid-open No. 2002-330735

Patent Document 2: Re-publication of PCT International Publication 2002/067702

Patent Document 3: Japanese Patent Application Laid-open No. 2006-166870

Patent Document 4: Japanese Patent Application Laid-open No. 2005-13167

Patent Document 5: Japanese Patent Application Laid-open No. 2013-94129

Patent Document 6: Japanese Patent Application Laid-open No. 2012-50396

### SUMMARY OF INVENTION

### Technical Problem

An object of the present invention is to provide a carbonate stimulation enhancer that allows maintenance of pleasant carbonate stimulation even in cases where carbonated beverages serving as beverages for quenching thirst have decreased performances and palatability because of reduced “carbonate stimulation sensation” that is due to weakening of pleasant and strong stimulus sensation of gaseous carbonic acid required for carbonated beverages, this weakening being the result of the necessity to reduce gas pressure during packing of carbonated beverages in accordance with heat sterilisation conditions, or of carbonated beverages “going flat” because of decreased gas pressure due to gas permeability of containers or rapid degassing of gaseous carbonic acid after opening a container.

### Solution to Problem

The inventors of the present invention conducted intensive studies in order to attain the above-stated object and found that preferable carbonate stimulation due to gaseous carbonic acid is enhanced and maintained by adding an undecatriene such as 6,8,10-undecatrien-3-one and 1,3,5-undecatriene or an undecatetraene such as 1,3,5,7-undecatetraene to a carbonated beverage, thereby accomplishing the present invention.

Thus the present invention provides the followings:

(1) a carbonate stimulation enhancer consisting of one or more selected from the group consisting of 6,8,10-undecatrien-2-one, 6,8, 10-undecatrien-3-one, 6,8,10-undecatrien-4-one, 6,8,10-undecatrien-3-ol, 6,8,10-undecatrien-4-ol, 1,3,5-undecatriene and 1,3,5,7-undecatetraene;

(2) a composition for enhancing carbonate stimulation including one or more selected from the group consisting of 6,8,10-undecatrien-2-one, 6,8,10-undecatrien-3-one, 6,8,10-undecatrien-4-one, 6,8,10-undecatrien-3-ol, 6,8,10-undecatrien-4-ol, 1,3,5-undecatriene and 1,3,5,7-undecatetraene;

(3) the composition for enhancing carbonate stimulation according to (2), including one or more warm sensation-imparting substances selected from the group consisting of capsicum extract, pepper extract, ginger extract, zanthoxylum extract, jambu oleoresin, capsaicin, dihydrocapsaicin, nordihydrocapsaicin, piperine, sanshool, hydroxysanshool, sanshoamide, spilanthol, gingerol and shogaol and/or one or more cool sensation-imparting substances selected from the group consisting of peppermint oil, spearmint oil, mint oil, eucalyptus oil, menthol, menthyl acetate, menthyl lactate, menthone, isomenthone, menthyl 3-hydroxybutyrate, monomenthyl succinate, pulegol, isopulegol, carvone, cineol, ethyl 3-(p-menthane-3-carboxamide)acetate and N-(4-methoxyphenyl)-2-isopropyl-5-methylcyclohexane carboxamide;

(4) a method for enhancing carbonate stimulation of a beverage, including adding to the beverage one or more selected from the group consisting of 6,8,10-undecatrien-2-one, 6,8,10-undecatrien-3-one, 6,8,10-undecatrien-4-one, 6,8,10-undecatrien-3-ol, 6,8,10-undecatrien-4-ol, 1,3,5-undecatriene and 1,3,5,7-undecatetraene; and

(5) the method for enhancing carbonate stimulation of the beverage according to (4), including adding to the beverage one or more warm sensation-imparting substances selected from the group consisting of capsicum extract, pepper extract, ginger extract, zanthoxylum extract, jambu oleoresin, capsaicin, dihydrocapsaicin, nordihydrocapsaicin, piperine, sanshool, hydroxysanshool, sanshoamide, spilanthol, gingerol and shogaol and/or one or more cool sensation-imparting substances selected from the group consisting of peppermint oil, spearmint oil, mint oil, eucalyptus oil, menthol, menthyl acetate, menthyl lactate, menthone, isomenthone, menthyl 3-hydroxybutyrate, monomenthyl succinate, pulegol, isopulegol, carvone, cineol, ethyl 3-(p-menthane-3-carboxamide)acetate and N-(4-methoxyphenyl)-2-isopropyl-5-methylcyclohexane carboxamide.

### Effects of Invention

According to the present invention, the addition of the abovementioned carbonate stimulation enhancer can prevent reduction in carbonate stimulation even in cases where “carbonate stimulation sensation” is reduced due to weakening of pleasant and strong stimulus sensation of gaseous carbonic acid required for carbonated beverages, this weakening being the result of the necessity to reduce gas pressure during packing of carbonated beverages or carbonated beverages “going flat” because of decreased gas pressure due to gas permeability of containers or rapid degassing of gaseous carbonic acid after opening a container, and thus essential performances and palatability of carbonated beverages, as beverages for quenching thirst, are sufficiently maintained even after opening a container.

### DESCRIPTION OF EMBODIMENTS

The present invention is hereinafter more specifically described. With regard to the present invention, it should be understood that the terms which are not specifically defined herein have the definitions and meanings that are generally understood in the art.

As used herein, “consisting of” is used with the notion that any element or item other than impurities and contaminants generally accompanying the element(s) or item(s) specifically described is excluded. On the other hand, “including” or “comprising” is used with the notion that any element or item other than the element(s) or item(s) specifically described is encompassed.

As used herein, 6,8,10-undecatrien-2-one represents one or more compounds selected from 6(E),8(E),10-undecatrien-2-one, 6(Z),8(E),10-undecatrien-2-one, 6(E),8(Z),10-undecatrien-2-one and 6(Z),8(Z),10-undecatrien-2-one.

As used herein, 6,8,10-undecatrien-3-one represents one or more compounds selected from 6(E),8(E),10-undecatrien-3-one, 6(Z),8(E),10-undecatrien-3-one, 6(E),8(Z),10-undecatrien-3-one and 6(Z),8(Z),10-undecatrien-3-one.

As used herein, 6,8,10-undecatrien-4-one represents one or more compounds selected from 6(E),8(E),10-undecatrien-4-one, 6(Z),8(E),10-undecatrien-4-one, 6(E),8(Z),10-undecatrien-4-one and 6(Z),8(Z),10-undecatrien-4-one.

As used herein, 6,8,10-undecatrien-3-ol represents one or more compounds selected from 6(E),8(E),10-undecatrien-3-ol, 6(Z),8(E),10-undecatrien-3-ol, 6(E),8(Z),10-undecatrien-3-ol and 6(Z),8(Z),10-undecatrien-3-ol.

As used herein, 6,8,10-undecatrien-4-ol represents one or more compounds selected from 6(E),8(E),10-undecatrien-4-ol, 6(Z),8(E),10-undecatrien-4-ol, 6(E),8(Z),10-undecatrien-4-ol and 6(Z),8(E)10-undecatrien-4-ol.

As used herein, 1,3,5-undecatriene represents one or more compounds selected from 1,3(E),5(E)-undecatriene, 1,3(E),5(Z)-undecatriene, 1,3(Z),5(E)-undecatriene and 1,3(Z),5(Z)-undecatriene.

As used herein, 1,3,5,7-undecatetraene represents one or more compounds selected from 1,3(E),5(E),7(E)-undecatetraene, 1,3(E),5(E),7(Z)-undecatetraene, 1,3(E),5(Z),7(E)-undecatetraene, 1,3(Z),5(E),7(E)-undecatetraene, 1,3(Z),5(E),7(Z)-undecatetraene, 1,3(E),5(Z),7(Z)-undecatetraene, 1,3(Z),5(Z),7(E)-undecatetraene and 1,3(Z),5(Z),7(Z)-undecatetraene.

6,8,10-Undecatrien-2-one used in the present invention is a known fragrance compound having a green note with a dry woody tone as well as sweet and fruity aroma and flavour with full of naturalness and freshness. The carbonate stimulation enhancing effect thereof has not been reported to date. As described above, 6,8,10-undecatrien-2-one has three double bonds and includes four geometric isomers. 6,8,10-Undecatrien-2-one which can be used may be the one obtained by chemical synthesis (such as the one synthesised according to the method disclosed in Japanese Patent Application Laid-open No. 2009-84189).

6,8,10-Undecatrien-3-one used in the present invention is known as YUZUNONE (registered trademark by T. Hasegawa Co., Ltd.) and is a known fragrance compound naturally found in galbanum or the pericarp of citrus yuzu. The carbonate stimulation enhancing effect thereof has not been reported to date. As described above, 6,8,10-undecatrien-3-one has three double bonds and includes four geometric isomers. 6,8,10-Undecatrien-3-one which can be used may be the one obtained by extraction from a natural source such as galbanum or the pericarp of yuzu, the one obtained by chemical synthesis (such as the ones synthesised according to the methods disclosed in Japanese Patent Application Laid-open Nos. 2009-19026 and 2011-12037), or a combination of the one obtained from a natural source and the one obtained by chemical synthesis.

6,8,10-Undecatrien-4-one used in the present invention is a known fragrance compound naturally found in galbanum. The carbonate stimulation enhancing effect thereof has not been reported to date. As described above, 6,8,10-undecatrien-4-one has three double bonds and includes four geometric isomers. 6,8,10-Undecatrien-4-one which can be used may be the one obtained by extraction from galbanum, the one obtained by chemical synthesis (such as the one synthesised according to the method disclosed in Japanese Patent Application Laid-open No. 2009-84190), or a combination of the one obtained from a natural source and the one obtained by chemical synthesis.

6,8,10-Undecatrien-3-ol or 4-ol used in the present invention is a known fragrance compound naturally found in the pericarp of yuzu. The carbonate stimulation enhancing effect thereof has not been reported to date. As described above, 6,8,10-undecatrien-3-ol or 4-ol has three double bonds and includes four geometric isomers. 6,8,10-Undecatrien-3-one or 4-ol which can be used may be the one obtained by extraction from the pericarp of yuzu, the one obtained by chemical synthesis (such as the one synthesised according to the method disclosed in Japanese Patent Application Laid-open No. 2009-19029), or a combination of the one obtained from a natural source and the one obtained by chemical synthesis.

1,3,5-Undecatriene used in the present invention is a known fragrance compound naturally found in galbanum, the pericarp of yuzu, etc. The carbonate stimulation enhancing effect thereof has not been reported to date. As described above, 1,3,5-undecatriene has three double bonds and includes four geometric isomers. 1,3,5-Undecatriene which can be used may be the one obtained by extraction from a natural source such as galbanum and the pericarp of yuzu, the one obtained by chemical synthesis (such as the one synthesised according to the method disclosed in Japanese Patent Application Laid-open No. S50-32105), or a combination of the one obtained from a natural source and the one obtained by chemical synthesis.

1,3,5,7-Undecatetraene used in the present invention is a known fragrance compound naturally found in lovage, citrus jabara, etc. The carbonate stimulation enhancing effect thereof has not been reported to date. As described above, 1,3,5,7-undecatetraene has four double bonds and includes eight geometric isomers. 1,3,5,7-Undecatetraene which can be used may be the one obtained by extraction from a natural source, the one obtained by chemical synthesis (such as the one synthesised according to the method disclosed in Japanese Patent Application Laid-open No. S59-42326), or a combination of the one obtained from a natural source and the one obtained by chemical synthesis.

6,8,10-undecatrien-2-one, 6,8,10-undecatrien-3-one, 6,8,10-undecatrien-4-one, 6,8,10-undecatrien-3-ol, 6,8,10-undecatrien-4-ol and 1,3,5-undecatriene used in the present invention are collectively referred to as “undecatriene” and 1,3,5,7-undecatetraene is collectively referred to as “undecatetraene”.

The carbonate stimulation enhancing effect can be further enhanced by adding, in addition to the undecatriene and undecatetraene, a warm sensation-imparting substance. The warm sensation-imparting substance used in the present invention is not particularly limited as far as it is a substance which imparts a warm sensation during use or exhibits a warming effect. Examples thereof include capsicum extract, pepper extract, ginger extract, zanthoxylum extract, jambu oleoresin, capsicum oleoresin, ginger oleoresin, capsaicin, dihydrocapsaicin, nordihydrocapsaicin, vanillyl ethyl ether, vanillyl propyl ether, vanillyl butyl ether, nonanoic acid vanillylamide, piperine, sanshool, hydroxysanshool, sanshoamide, spilanthol, gingerol, shogaol, zingerone and the like.

The warm sensation-imparting substance which can be added may be the one synthetically obtained or a single compound isolated from a natural source, or may be a so-called spice extract obtained by extraction or distillation of a spice.

The carbonate stimulation enhancing effect can be further enhanced by adding, in addition to the undecatriene and undecatetraene, a cool sensation-imparting substance. The cool sensation-imparting substance used in the present invention is not particularly limited as far as it is a substance which imparts a cool sensation during use or exhibits a cooling effect. Examples thereof include peppermint oil, spearmint oil, mint oil, eucalyptus oil, menthol, menthyl acetate, menthyl lactate, menthone, isomenthone, menthyl 3-hydroxybutyrate, monomenthyl succinate, pulegol, isopulegol, carvone, cineol, camphor, eugenol, borneol, ethyl 3-(p-menthane-3-carboxamide)acetate, N-(4-methoxyphenyl)-2-isopropyl-5-methylcyclohexane carboxamide, 3-(1-menthoxy)propane-1,2-diol, para-menthane-3,8-diol, 1-menthyl-3-hydroxybutyrate and the like.

The cool sensation-imparting substance which can be added may be the one synthetically obtained or a single compound isolated from a natural source, or may be so-called essential oil containing the cool sensation-imparting substance obtained by extraction or distillation of a plant.

When the undecatriene and undecatetraene is added to food and beverages including carbonated beverages, the undecatriene and the undecatetraene may be used separately or in combination. The concentration of the undecatriene and/or undecatetraene in a food or beverage may vary according to the required intensity of carbonate stimulation and is not particularly limited. Generally, the carbonate stimulation can be enhanced by adding at a concentration of 0.01 ppt to 1 ppb, preferably 0.1 ppt to 100 ppt and more preferably 0.5 ppt to 20 ppt to a food or beverage corresponding to a final product.

The effect of carbonate stimulation is further enhanced by further adding to the undecatriene and undecatetraene a warm sensation-imparting substance and/or a cool sensation-imparting substance. The concentration of the warm sensation-imparting substance and/or cool sensation-imparting substance in a food or beverage is desirably at or less than the threshold of manifestation of warm or cool sensation. Specifically, the concentration of the warm sensation-imparting substance may be 0.01 ppm to 100 ppm and preferably 0.05 ppm to 50 ppm, and the concentration of the cool sensation-imparting substance may be 0.01 ppm to 50 ppm and preferably 0.05 ppm to 20 ppm.

Addition of the carbonate stimulation enhancer of the present invention prevents reduction in carbonate stimulation in carbonated beverages that may “go flat” and have weakened stimulus sensation of gaseous carbonic acid which is otherwise pleasant and strong as required for carbonated beverages because of the decreased gas pressure during packing, the decreased gas pressure due to gas permeability of containers or rapid degassing of gaseous carbonic acid after opening.

A food or beverage to which the carbonate stimulation enhancer of the present invention can be added is not particularly limited as far as it exhibits carbonate stimulation. Examples thereof include carbonated beverages as well as carbonic acid-containing alcoholic beverages, chilled and frozen desserts, candies, jellies, gummi candies, tablet-shaped candies, chewing gums and the like.

Carbonated beverages as used herein are not particularly limited as far as they are beverages containing carbon dioxide. Examples thereof include cola carbonated beverages, clear type carbonated beverages, fruit juice-containing carbonated beverages, fruit colored carbonated beverages, non-alcoholic carbonated beverages, lactic flavour carbonated beverages, carbonated water, other carbonated beverages and energy drink carbonated beverages. More specific examples thereof include soda pop, lemon pop, lemonlime pop, lemonade, orange pop, grape pop, apple pop, cola, guarana, ginger ale, tonic water, cream soda, non-alcoholic beer, non-alcoholic chuhai (shochu-based beverage) and non-alcoholic sparkling wine.

Examples of carbonated alcoholic beverages include beers such as beers and low-malt beers, liqueurs such as chuhai (shochu-based beverage), fruit liquors such as champagne and cider and energy drinks categorised in pharmaceutical drugs.

The present invention is further specifically described by way of Examples which do not limit the present invention.

### EXAMPLES

### Reference Example 1

### Preparation of Carbonated Beverage Crude Solution

Ion-exchange water was added to 13 Kg of high fructose corn syrup (Bx 75°), 0.14 Kg of citric acid (crystals) and 0.04 Kg of trisodium citrate to dissolve the components and the total volume was adjusted to 100 L (hereinafter referred to as “carbonated beverage crude solution”).

### Reference Example 2

### Preparation of Undecatriene and Undecatetraene

6,8,10-Undecatrien-2-one used was synthesised according to the method disclosed in Japanese Patent Application Laid-open No. 2009-84189. 6,8,10-Undecatrien-3-one used was synthesised according to the method disclosed in Japanese Patent Application Laid-open No. 2009-19026. 6,8,10-Undecatrien-4-one used was synthesised according to the method disclosed in Japanese Patent Application Laid-open No. 2009-84190. 6,8,10-Undecatrien-3-ol and 6,8,10-undecatrien-4-ol used were synthesised according to the method disclosed in Japanese Patent Application Laid-open No. 2009-19029. 1,3,5-Undecatriene used was synthesised according to the method disclosed in Japanese Patent Application Laid-open No. S50-32105. Finally, 1,3,5,7-undecatetraene used was synthesised according to the method disclosed in Japanese Patent Application Laid-open No. S59-42326.

### Example 1

### Enhancement of Carbonate Stimulation Using Undecatriene and Undecatetraene

The carbonated beverage crude solution alone (additive-free) and the carbonated beverage crude solutions to which 6,8,10-undecatrien-2-one, 6,8,10-undecatrien-3-one, 6,8,10-undecatrien-4-one, 6,8,10-undecatrien-3-ol, 6,8,10-undecatrien-4-ol, 1,3,5-undecatriene and 1,3,5,7-undecatetraene at 1 ppt were respectively added were prepared. To each prepared solution, gaseous carbonic acid was injected, and each container was sealed on a tin can seamer which was controlled to provide an internal gas pressure of 2.0 kg/cm². The cans were placed in warm water so as to attain the central temperature of 65° C. and kept thereafter at 65° C. for 10 minutes for sterilisation. The cans were then cooled under cold water to produce carbonated beverages. The additive-free carbonated beverage was designated as Comparative Product 1 and the carbonated beverages containing the undecatriene and undecatetraene were designated as Products 1 to 7 of the invention.

The carbonate stimulation of the beverages were evaluated in a sensory test carried out by 27 trained panelists. The carbonate stimulation was evaluated on a 7-point scale with assessing Comparative Product 1 as no change (4 points). Averages of the scores are shown in Table 1.

### Rating Criteria

Significantly strong stimulation: 7 points

Strong stimulation: 6 points

Slightly strong stimulation 5 points

No change: 4 points

Slightly weak stimulation: 3 points

Weak stimulation: 2 points

Significantly weak stimulation: 1 point

TABLE 1
Evaluation of carbonate stimulation

| | | Carbonate |
|---|---|---|
| | | stimulation |
| | Additive | score |
| Comparative Product 1 | Additive-free | 4.0 |
| Product 1 of the invention | 6,8,10-undecatrien-2-one | 5.2 |
| Product 2 of the invention | 6,8,10-undecatrien-3-one | 6.0 |
| Product 3 of the invention | 6,8,10-undecatrien-4-one | 5.6 |
| Product 4 of the invention | 6,8,10-undecatrien-3-ol | 5.3 |
| Product 5 of the invention | 6,8,10-undecatrien-4-ol | 5.8 |
| Product 6 of the invention | 1,3,5-undecatriene | 4.6 |
| Product 7 of the invention | 1,3,5,7-undecatetraene | 5.9 |

As shown in Table 1, it is apparent that addition of the undecatriene and undecatetraene to a carbonated beverage can enhance carbonate stimulation of the carbonated beverage.

### Example 2

### Variation in Carbonate Stimulation According to Gas Pressure and Concentration of 6,8,10-undecatrien-3-one)

To the carbonated beverage crude solution prepared in the same manner as in Example 1, 6,8,10-undecatrien-3-one was added at 0 ppt, 0.1 ppt, 0.5 ppt, 1 ppt, 5 ppt, 10 ppt and 20 ppt, respectively. To each prepared solution, gaseous carbonic acid was injected, and each container was sealed on a tin can seamer which was controlled to provide an internal gas pressure of 2.0 kg/cm². The cans were placed in warm water so as to attain the central temperature of 65° C. and kept thereafter at 65° C. for 10 minutes for sterilisation. The cans were then cooled under cold water to produce carbonated beverages. The additive-free carbonated beverage was designated as Comparative Product 2 and the carbonated beverages containing 6,8,10-undecatrien-3-one were designated as Products 8 to 13 of the invention.

Further, carbonated beverages containing 6,8,10-undecatrien-3-one at the same concentrations as above were prepared under the internal gas pressure of 3.0 kg/cm². The additive-free carbonated beverage was designated as Comparative Product 3 and the carbonated beverages containing 6,8,10-undecatrien-3-one were designated as Products 14 to 19 of the invention.

The carbonate stimulation of the beverages were evaluated in a sensory test carried out by 27 trained panelists. The carbonate stimulation was evaluated on a 7-point scale with assessing Comparative Product 2 as no change (4 points) for the samples prepared under the gas pressure of 2.0 kg/cm² and on a 7-point scale with assessing Comparative Product 3 as no change (4 points) for the samples prepared under the gas pressure of 3.0 kg/cm². The rating criteria used was the same as in Example 1. Averages of the scores are shown in Table 2.

TABLE 2
Evaluation of carbonate stimulation of 6,8,10-undecatrien-3-one

| | Gas | | Carbonate | |
|---|---|---|---|---|
| | pressure | Concentration | stimulation | Flavour |
| | (kg/cm²) | (ppt) | score | evaluation |
| Comparative | 2.0 | 0 | 4.0 | |
| Product 2 | | | | |
| Product 8 of | | 0.1 | 4.3 | No flavour |
| the invention | | | | |
| Product 9 of | | 0.5 | 5.7 | No flavour |
| the invention | | | | |
| Product 10 of | | 1 | 6.0 | No flavour |
| the invention | | | | |
| Product 11 of | | 5 | 6.0 | No flavour |
| the invention | | | | |
| Product 12 of | | 10 | 6.2 | Only slight |
| the invention | | | | flavour |
| Product 13 of | | 20 | 6.1 | Some |
| the invention | | | | flavour |
| Comparative | 3.0 | 0 | 4.0 | |
| Product 3 | | | | |
| Product 14 of | | 0.1 | 4.4 | No flavour |
| the invention | | | | |
| Product 15 of | | 0.5 | 5.6 | No flavour |
| the invention | | | | |
| Product 16 of | | 1 | 5.9 | No flavour |
| the invention | | | | |
| Product 17 of | | 5 | 6.2 | No flavour |
| the invention | | | | |
| Product 18 of | | 10 | 6.2 | Only slight |
| the invention | | | | flavour |
| Product 19 of | | 20 | 6.1 | Slight |
| the invention | | | | flavour |

As apparent from Table 2, it is demonstrated that an addition at as low as 0.1 ppt exhibited the carbonate stimulation enhancing effect with addition at 0.5 ppt or more exhibiting more significant effects. When 6,8,10-undecatrien-3-one was added at 20 ppt, although the carbonate stimulation enhancing effect could be observed, the aroma of 6,8,10-undecatrien-3-one was imparted as a flavour despite the flavour being unnoticeable.

### Example 3

### (Variation in Carbonate Stimulation According to Gas Pressure and Concentration of 1,3,5, 7-undecatetraene

To the carbonated beverage crude solution prepared in the same manner as in Example 1, 1,3,5,7-undecatetraene was added at 0 ppt, 0.1 ppt, 0.5 ppt, 1 ppt, 5 ppt, 10 ppt and 20 ppt, respectively. To each prepared solution, gaseous carbonic acid was injected, and each container was sealed on a tin can seamer which was controlled to provide an internal gas pressure of 2.0 kg/cm². The cans were placed in warm water so as to attain the central temperature of 65° C. and kept thereafter at 65° C. for 10 minutes for sterilisation. The cans were then cooled under cold water to produce carbonated beverages. The additive-free carbonated beverage was designated as Comparative Product 4 and the carbonated beverages containing 1,3,5,7-undecatetraene were designated as Products 20 to 25 of the invention.

Further, carbonated beverages containing 1,3,5,7-undecatetraene at the same concentrations as above were prepared under the internal gas pressure of 3.0 kg/cm². The additive-free carbonated beverage was designated as Comparative Product 5 and the carbonated beverages containing 1,3,5,7-undecatetraene were designated as Products 26 to 31 of the invention.

The carbonate stimulation of the beverages were evaluated in a sensory test carried out by 27 trained panelists. The carbonate stimulation was evaluated on a 7-point scale with assessing Comparative Product 4 as no change (4 points) for the samples prepared under the gas pressure of 2.0 kg/cm² and on a 7-point scale with assessing Comparative Product 5 as no change (4 points) for the samples prepared under the gas pressure of 3.0 kg/cm². The rating criteria used were the same as in Example 1. Averages of the scores are shown in Table 3.

TABLE 3
Evaluation of carbonate stimulation of 1,3,5,7-undecatetraene

| | Gas | | Carbonate | |
|---|---|---|---|---|
| | pressure | Concentration | stimulation | Flavour |
| | (kg/cm²) | (ppt) | score | evaluation |
| Comparative | 2.0 | 0 | 4.0 | |
| Product 4 | | | | |
| Product 20 of | | 0.1 | 4.5 | No flavour |
| the invention | | | | |
| Product 21 of | | 0.5 | 5.6 | No flavour |
| the invention | | | | |
| Product 22 of | | 1 | 5.9 | No flavour |
| the invention | | | | |
| Product 23 of | | 5 | 6.0 | No flavour |
| the invention | | | | |
| Product 24 of | | 10 | 6.1 | Only slight |
| the invention | | | | flavour |
| Product 25 of | | 20 | 6.2 | Slight |
| the invention | | | | flavour |
| Comparative | 3.0 | 0 | 4.0 | |
| Product 5 | | | | |
| Product 26 of | | 0.1 | 4.4 | No flavour |
| the invention | | | | |
| Product 27 of | | 0.5 | 5.5 | No flavour |
| the invention | | | | |
| Product 28 of | | 1 | 6.1 | No flavour |
| the invention | | | | |
| Product 29 of | | 5 | 6.2 | No flavour |
| the invention | | | | |
| Product 30 of | | 10 | 6.1 | Only slight |
| the invention | | | | flavour |
| Product 31 of | | 20 | 6.0 | Slight |
| the invention | | | | flavour |

As apparent from Table 3, it is demonstrated that an addition at as low as 0.1 ppt exhibited the carbonate stimulation enhancing effect with addition at 0.5 ppt or more exhibiting more significant effects. When 1,3,5,7-undecatetraene was added at 20 ppt, although the carbonate stimulation enhancing effect could be observed, the aroma of 1,3,5,7-undecatetraene was imparted as a flavour despite the flavour was unnoticeable.

### Example 4

### Change of Carbonate Stimulation Over Time

To the carbonated beverage crude solution prepared in the same manner as in Example 1, 6,8,10-undecatrien-3-one was added at 0 ppt or 1 ppt. To each prepared solution, gaseous carbonic acid was injected, and each PET bottle was sealed at an internal gas pressure of 2.0 kg/cm². The PET bottles were placed in warm water so as to attain the central temperature of 65° C. and kept thereafter at 65° C. for 10 minutes for sterilisation. The bottles were then cooled under cold water to produce carbonated beverages. The carbonated beverages were then opened once, left to stand over 5 minutes, resealed and stored in a refrigerator for 12 hours. The additive-free carbonated beverage after the storage was designated as Comparative Product 6 and the beverage containing 6,8,10-undecatrien-3-one at 1 ppt after the storage was designated as Product 32 of the invention.

The carbonate stimulation of the beverages were evaluated in a sensory test carried out by 27 trained panelists. The carbonate stimulation was evaluated on a 7-point scale with assessing Comparative Product 2 as no change (4 points). The rating criteria used was the same as in Example 1. Averages of the scores are shown in Table 4.

TABLE 4
Change in evaluation of carbonate stimulation
of 6,8,10-undecatrien-3-one

| | Time after | | Carbonate |
|---|---|---|---|
| | opening | Concentration | stimulation |
| | (hour) | (ppt) | score |
| Comparative Product 2 | 0 | 0 | 4.0 |
| Product 10 of the invention | | 1 | 6.0 |
| Comparative Product 6 | 12 | 0 | 1.2 |
| Product 32 of the invention | | 1 | 3.1 |

From the results in Table 4, it is demonstrated that Comparative Product 6, which was the carbonated beverage without 6,8,10-undecatrien-3-one stored for 12 hours after opening, had significantly weakened carbonate stimulation. In contrast, Product 32 of the invention, which was the carbonated beverage containing 6,8,10-undecatrien-3-one at 1 ppt stored for 12 hours after opening, was evaluated to retain some carbonate stimulation, while it was slightly weakened, and thus it is demonstrated that addition of 6,8,10-undecatrien-3-one maintains carbonate stimulation compared to the absence of 6,8,10-undecatrien-3-one.

### Reference Example 3

### Preparation of Capsicum Extract

Commercially available dried red pepper (100 g) was milled in a mixer to which 1000 g of 60% (v/v) ethanol aqueous solution was added. The mixture was stirred at 65° C. for 3 hours, cooled to 20° C. and centrifuged followed by vacuum filtration using diatomaceous earth as a filter aid to give 865 g of capsicum extract (Reference Product 1).

### Example 5

### Carbonate Stimulation by Addition of 6,8,10-undecatrien-3-one and a Warm Sensation-Imparting Substance or a Cool Sensation-Imparting Substance

To the carbonated beverage crude solution prepared in the same manner as in Example 1, no additive, 5 ppt of 6,8,10-undecatrien-3-one, or 5 ppt of 6,8,10-undecatrien-3-one and a warm sensation-imparting substance which was 20 ppm of capsicum extract or 5 ppm of piperine, or a cool sensation-imparting substance which was 1 ppm of menthol or 0.05 ppm of ethyl 3-(p-menthane-3-carboxamide)acetate (WS-5) were added. To each prepared solution, gaseous carbonic acid was injected, and each container was sealed on a tin can seamer which was controlled to provide an internal gas pressure of 2.0 kg/cm². The cans were placed in warm water so as to attain the central temperature of 65° C. and kept thereafter at 65° C. for 10 minutes for sterilisation. The cans were then cooled under cold water to produce carbonated beverages. The additive-free carbonated beverage was designated as Comparative Product 2, the carbonated beverage containing 6,8,10-undecatrien-3-one was designated as Product 33 of the invention, the carbonated beverages further containing warm sensation-imparting substances were designated as Products 34 and 35 of the invention and the carbonated beverages further containing cool sensation-imparting substances were designated as Products 36 and 37 of the invention.

The carbonate stimulation of the beverages were evaluated in a sensory test carried out by 27 trained panelists. The carbonate stimulation was evaluated on a 7-point scale with assessing Comparative Product 2 as no change (4 points). The rating criteria used was the same as in Example 1. Averages of the scores are shown in Table 5.

TABLE 5
Evaluation of carbonate stimulation when warm sensation-imparting
substances and cool sensation-imparting substances were added

| | | Carbonate |
|---|---|---|
| | | stimulation |
| | Additive | score |
| Comparative | Additive-free | 4.0 |
| Product 2 | | |
| Product 33 of | 6,8,10-undecatrien-3-one: 5 ppt | 6.0 |
| the invention | | |
| Product 34 of | 6,8,10-undecatrien-3-one: 5 ppt | 6.5 |
| the invention | and capsicum extract: 20 ppm | |
| Product 35 of | 6,8,10-undecatrien-3-one: 5 ppt | 6.5 |
| the invention | and piperine: 5 ppm | |
| Product 36 of | 6,8,10-undecatrien-3-one: 5 ppt | 6.3 |
| the invention | and menthol 1 ppm | |
| Product 37 of | 6,8,10-undecatrien-3-one: 5 ppt and | 6.4 |
| the invention | ethyl 3-(p-menthane-3-carboxamide)acetate: | |
| | 0.05 ppm | |

From the results in Table 5, it is demonstrated that further addition of warm sensation-imparting substance or cool sensation-imparting substance could enhance carbonate stimulation compared to the sole addition of 6,8,10-undecatrien-3-one.

1. A composition for enhancing carbonate stimulation comprising one or more selected from the group consisting of 6,8,10-undecatrien-2-one, 6,8,10-undecatrien-3-one, 6,8,10-undecatrien-4-one, 6,8,10-undecatrien-3-ol, 6,8,10-undecatrien-4-ol, 1,3,5-undecatriene and 1,3,5,7-undecatetraene.

2. A carbonate stimulation enhancer consisting of one or more selected from the group consisting of 6,8,10-undecatrien-2-one, 6,8,10-undecatrien-3-one, 6,8,10-undecatrien-4-one, 6,8,10-undecatrien-3-ol, 6,8,10-undecatrien-4-ol, 1,3,5-undecatriene and 1,3,5,7-undecatetraene.

3. The composition for enhancing carbonate stimulation according to claim 1, comprising one or more warm sensation-imparting substances selected from the group consisting of capsicum extract, pepper extract, ginger extract, zanthoxylum extract, jambu oleoresin, capsaicin, dihydrocapsaicin, nordihydrocapsaicin, piperine, sanshool, hydroxysanshool, sanshoamide, spilanthol, gingerol and shogaol and/or one or more cool sensation-imparting substances selected from the group consisting of peppermint oil, spearmint oil, mint oil, eucalyptus oil, menthol, menthyl acetate, menthyl lactate, menthone, isomenthone, menthyl 3-hydroxybutyrate, monomenthyl succinate, pulegol, isopulegol, carvone, cineol, ethyl 3-(p-menthane-3-carboxamide)acetate and N-(4-methoxyphenyl)-2-isopropyl-5-methylcyclohexane carboxamide.

4. A method for enhancing carbonate stimulation of a beverage, comprising adding to the beverage one or more selected from the group consisting of 6,8,10-undecatrien-2-one, 6,8,10-undecatrien-3-one, 6,8,10-undecatrien-4-one, 6,8,10-undecatrien-3-ol, 6,8,10-undecatrien-4-ol, 1,3,5-undecatriene and 1,3,5,7-undecatetraene.

5. The method for enhancing carbonate stimulation of a beverage according to claim 4, comprising adding to the beverage one or more warm sensation-imparting substances selected from the group consisting of capsicum extract, pepper extract, ginger extract, zanthoxylum extract, jambu oleoresin, capsaicin, dihydrocapsaicin, nordihydrocapsaicin, piperine, sanshool, hydroxysanshool, sanshoamide, spilanthol, gingerol and shogaol and/or one or more cool sensation-imparting substances selected from the group consisting of peppermint oil, spearmint oil, mint oil, eucalyptus oil, menthol, menthyl acetate, menthyl lactate, menthone, isomenthone, menthyl 3-hydroxybutyrate, monomenthyl succinate, pulegol, isopulegol, carvone, cineol, ethyl 3-(p-menthane-3-carboxamide)acetate and N-(4-methoxypheny)-2-isopropyl-5-methylcyclohexane carboxamide.
